(19) United States
(12) Patent Application Publication
(10) Pub. No.: US 2011/0146972 A1
(43) Pub. Date: Jun. 23, 2011

(54) ELECTRICAL CONTACT CONNECTIONS FOR WELLBORE TOOLS

(76) Inventors: Loic Vide, Oslo (NO); Luke T. Perkins, Plainsboro, NJ (US); James E. Fay, Lawrenceville, NJ (US)

(21) Appl. No.: 12/682,189

(22) PCT Filed: Oct. 16, 2008
(86) PCT No.: PCT/US08/80139

§ 371 Date: Apr. 8, 2010

Related U.S. Application Data
(60) Provisional application No. 60/980,525, filed on Oct. 17, 2007.

(51) Int. Cl. H01R 13/02; H01R 13/03

(52) U.S. Cl. 166/242.6; 439/884; 439/887

(57) ABSTRACT

A logging-while-drilling (LWD) tool includes a bottomhole assembly (BHA); an electronic device carried on the BHA; and a bunched wire contact providing an electrical connection between the electronic device and a electrical power source at the BHA. The bunched wire contact includes a plurality of wires each of which has sufficient capacity to provide the requisite electrical current for operation of the electronic device.

### RELATED APPLICATIONS

This application claims the benefit of U.S. Provisional Patent Application No. 60/980,525, filed on Oct. 17, 2007.

### TECHNICAL FIELD

The present invention relates in general to electrical connections, and, more particularly, but not by way of limitation, to high-voltage electrical contacts for providing a robust electrical connection in a wellbore tool.

### BACKGROUND

Logging-while-drilling (LWD) tools are used while drilling wellbores or proximate to drilling to obtain formation data prior to excessive damage to the surrounding formation. LWD tools are incorporated in bottomhole assembly proximate to the drill bit and as such endure excessive shock and vibration. In addition the tools and the electrical connection must also withstand the downhole temperatures and a range of temperatures as the tool is moved up and down the wellbore.

### SUMMARY

One embodiment of an electric contact assembly for electrically connecting a first device and a second device includes a contact stem conductively connected to the first device and a bunched wire contact conductively connected to the second device and electrically connecting the first device and the second device, wherein the bunched wire contact includes a plurality of wires.

An embodiment of a wellbore tool includes an electronic device; an electrical power source; and a bunched wire contact electrically connecting the electronic device and the electrical power source, wherein the bunched wire contact includes a plurality of electrically conductive wires.

An embodiment of a logging-while-drilling (LWD) tool includes a bottomhole assembly (BHA); an electronic device carried on the BHA; and a bunched wire contact providing an electrical connection between the electronic device and a electrical power source at the BHA. Wherein, the bunched wire contact includes a plurality of wires each of which has sufficient capacity to provide the requisite electrical current for operation of the electronic device.

The foregoing has outlined some of the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

A more complete understanding of the present invention may be obtained by reference to the following Detailed Description of Illustrative Embodiments, when taken in conjunction with the accompanying Drawings, wherein:

FIG. 1 is well schematic illustrating a logging-while-drilling tool of the present invention disposed in a wellbore; and

FIG. 2 is a cross-sectional view of a portion of a wellbore tool illustrating an electrical contact connection of the present invention.

### DETAILED DESCRIPTION OF ILLUSTRATIVE EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention is described herein with reference to a LWD system for purposes of illustration. It is recognized that the device, system and methods of the present invention may be utilized with other systems and tools that include connection of an electronic device to a source of electricity.

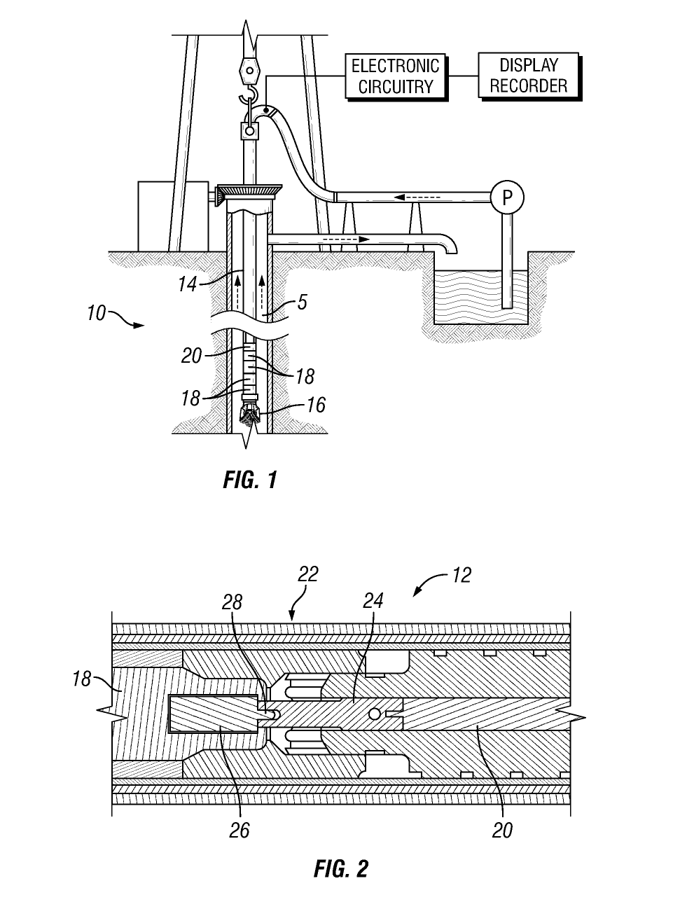

FIG. 1 illustrates a logging-while-drilling (LWD) system 10 according to an embodiment of the present invention. LWD system 10 includes a bottomhole assembly (BHA) 12 connected in a drill string 14 for use in a wellbore 5. In the illustrated embodiment, BHA 12 includes a drilling bit 16, one or more electronic devices 18 and an electric source 20. In the illustrated embodiment, BHA 12 includes multiple electronic devices 18 which may be referred to from time to time herein as electronic devices, downhole tools, logging tools and the like. Examples of electronic downhole tools 18 include, without limitation, formation evaluation tools, sensors, communication devices, antennae and measurement-while-drilling (MWD) tools. It should be recognized that electronic device 18 may be any electronic device requiring an electrical connection for supply of electricity. Electric source 20 is illustrated as a local electric source, such as a battery, connected with BHA 12 for providing high voltage electricity to electronic device 18. It should be recognized that electric source 20 may be located distal from electronic device 18, such as at the surface of drilling operations.

FIG. 2 is a cross-sectional view of portion of BHA 12 of FIG. 1 illustrating an electrical connector, generally denoted by the numeral 22, of the present invention. Electrical connector 22, in the illustrated embodiment, includes a contact stem 24 and contact 26. Electrical connector 22 is electrically connecting electric power source 20, illustrated as a cable, and downhole tool 18. In this embodiment, contact stem 24 is associated with electric source 20 and contact 26 is associated with downhole tool 18, however, the orientation and association may be reversed.

Contact 26 is adapted to be utilized in a downhole tool, such as a LWD tool, to provide a reliable electrical bridge while enduring the shock and vibrations associated with wellbore operations. Contact 26 is further adapted to continuously provide a reliable electrical bridge while enduring wellbore temperatures and the temperature cycles associated with wellbore operations. For example, contact 26 may provide a robust electrical bridge although subjected to a relative sliding motion from thermal expansion.

In one embodiment, contact 26 is constructed of a plurality of wires oriented in a bunched and intertwined relationship. The plurality of wires may be randomly coiled to act like a spring. Additionally, the plurality of wires may act like a spring and substantially retain the shape of the amalgam of wires. Because contact 26 is metallic it is not subjected to thermal setting. Further, the light mass of bunched wire contact 26 makes it easy to hold in place and to withstand shock and vibration, mitigating fretting and particulate generation.

In some embodiments, each of the plurality of wires is sufficient to supply the required voltage and current for the desired application. Thus, as will be further described below, ensures that a reliable electrical connection is maintained. Each of the plurality of wires is constructed of a material suited to endure the environmental conditions and temperature and to provide the requisite carrying capacity. In one embodiment, the wires of contact 26 are beryllium copper (BeCu), each wire having a diameter of approximately 0.002 inches (0.05 mm). Other suitable materials of construction may include, without limitation, rhodium, gold plated tungsten, and nickel chromium (NiCr).

Contact 26 may be formed in a variety of shapes to accommodate the application requirements. For example, contact 26 may be formed in a conical shape to such as for a lead in. In another embodiment (not illustrated), contact 26 may be form a recess section to provide an axial and/or radial electrical contact with a male portion of a contact. Contact 26 may be secured in a desired position in various manners including, without limitation, soldering and radial compression.

In the embodiment illustrated in FIG. 2, bunched wire contact 26 is formed in a generally cylindrical form having a reduced diameter pin end 28. Contact 26 is disposed in part within a corona shield cavity 30 formed in tool 18 with pin 28 exposed for electrically connecting with the second device, electric supply 20 in this embodiment.

In the illustrated embodiment, electrical connection is a contact type electrical connection. Thus, a high-voltage electrical connection occurs across the contact between bunched wire contact 26, and more particularly pin 28, and contact stem 24 with minimal or no direct mechanical contact or support.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. An electric contact assembly for electrically connecting a first device and a second device, the contact assembly comprising:
a contact stem conductively connected to the first device; and
a bunched wire contact conductively connected to the second device and electrically connecting the first device and the second device, the bunched wire contact comprising a plurality of wires.

2. The contact assembly of claim 1, wherein the plurality of wires are randomly coiled to form the bunched wired contact.

3. The contact assembly of claim 1, wherein each of the plurality of wires is sufficient to provide the requisite electrical current between the first and the second device.

4. The contact assembly of claim 1, wherein each of the plurality of wires is constructed of beryllium copper.

5. The contact assembly of claim 1, wherein there is no mechanical support provided between the connection of the bunched wire contact and the contact stem.

6. The contact assembly of claim 2, wherein each of the plurality of wires is sufficient to provide the requisite electrical current between the first and the second device.

7. The contact assembly of claim 2, wherein there is no mechanical support provided between the connection of the bunched wire contact and the contact stem.

8. The contact assembly of claim 6, wherein there is no mechanical support provided between the connection of the bunched wire contact and the contact stem.

9. The contact assembly of claim 1, wherein one of the first device or the second device comprises a high-voltage electrical source.

10. A wellbore tool, the tool comprising:
an electronic device;
an electrical power source; and
a bunched wire contact electrically connecting the electronic device and the electrical power source, the bunched wire contact comprising a plurality of electrically conductive wires.

11. The tool of claim 10, wherein the electrical power source comprises a battery disposed in a bottomhole assembly proximate to the electronic device.

12. The tool of claim 10, wherein each of the plurality of wires is sufficient to provide the requisite electrical current from the electrical power source to the electronic device to operate the electronic device.

13. The tool of claim 10, wherein there is no mechanical support at the electrical connection of the bunched wire contact and the electrical power supply.

14. The tool of claim 10, wherein the plurality of wires are randomly coiled to form the bunched wire contact.

15. The tool of claim 10, wherein the electronic device and the bunched wire contact are positioned in a bottomhole assembly.

16. The tool of claim 12, wherein there is no mechanical support at the electrical connection of the bunched wire contact and the electrical power supply.

17. The tool of claim 12, wherein the plurality of wires are randomly coiled to form the bunched wire contact.

18. The tool of claim 17, wherein there is no mechanical support at the electrical connection of the bunched wire contact and the electrical power supply.

19. A logging-while-drilling (LWD) tool, the tool comprising:
a bottomhole assembly (BHA);
an electronic device carried on the BHA; and
a bunched wire contact providing an electrical connection between the electronic device and a electrical power source at the BHA, the bunched wire contact comprising a plurality of wires each of which has sufficient capacity to provide the requisite electrical current for operation of the electronic device.

20. The tool of claim 19, wherein a mechanical support is not provided at the electrical connection of the bunched wire contact and the electrical power source.
